(19) United States
(12) Patent Application Publication
(10) Pub. No.: US 2026/0349418 A1
(43) Pub. Date: Nov. 5, 2026

(54) CONNECTED WORKFLOW SYSTEM WITH DATA INTEGRITY PROTECTION

(71) Applicant: Tyco Fire & Security GmbH, Neuhausen am Rheinfall (CH)

(72) Inventors: Dattatray More, Pune (IN); Ajay Kumar, Pune (IN); Robert A. Fox, Milwaukee, WI (US); Nilesh Patil, Pune (IN); Anand Joshi, Pune (IN); Christopher S. Gosline, Sacramento, CA (US); Gregory T. Reichl, Kaukana, WI (US); Krishan Kumar Sharma, Pune (IN)

(73) Assignee: Tyco Fire & Security GmbH, Neuhausen am Rheinfall (CH)

(21) Appl. No.: 19/460,733

(22) Filed: Jan. 27, 2026

(30) Foreign Application Priority Data
Apr. 30, 2025 (IN) 202511041783

(51) Int. Cl. G05B 19/418; G06F 11/3668

(52) U.S. Cl. CPC G05B 19/4184; G05B 19/4186; G06F 11/368

(57) ABSTRACT

A connected workflow system may include a mobile device and a computing system. The first mobile device may be configured to execute a workflow application causing collection of test data relating to the building equipment. The computing system may be configured to receive the test data from the workflow application, store a first batch of the test data as a first version, and store a second version based on the first batch of the test data. The second batch may be received from the workflow application after the first batch. The computing system may be configured to provide an indication of progress or completion of validating the testing of the building equipment without using the second version in response to a user request to revert to the first version.

### CROSS-REFERENCE TO RELATED PATENT APPLICATIONS

This application claims the benefit of and priority to Indian Provisional Patent Application No. 202511041783 filed Apr. 30, 2025, the entire disclosures of which are incorporated by reference herein.

### BACKGROUND

The present disclosure relates generally to building systems, including devices and equipment for a building as well as building management systems (BMS). More specifically, the present disclosure relates to installation and commissioning of building devices and equipment.

### SUMMARY

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

One implementation of the present disclosure relates to a system for validating testing of building equipment. The system includes a first mobile device and a computing system. The first mobile device is configured to execute a workflow application causing collection of test data relating to the building equipment. The computing system is configured to receive the test data from the workflow application, store a first batch of the test data as a first version, store a second version based on the first batch of the test data and a second batch of the test data, the second batch received from the workflow application after the first batch, and provide an indication of progress or completion of validating the testing of the building equipment without using the second version in response to a user request to revert to the first version.

Another implementation of the present disclosure relates to one or more non-transitory computer readable media storing program instructions related to validating testing of building equipment. When executed by one or more processors, the program instructions causes the one or more processors to perform operations including receiving test data from a workflow application, storing a first batch of the test data as a first version, storing a second version based on the first batch of the test data and a second batch of the test data, and providing an indication of progress or completion of validating the testing of the building equipment without using the second version in response to a user request to revert to the first version. The second batch is received from the workflow application after the first batch.

Another implementation of the present disclosure relates to a method to validate testing of building equipment. The method including receiving test data from a workflow application executed to cause collection of the test data relating to building equipment; storing, by a cloud server, a first batch of the test data as a first version; storing, by a cloud server, a second version based on the first batch of the test data and a second batch of the test data; and providing an indication of progress or completion of validating a testing of the building equipment without using the second version in response to a user request to revert to the first version. The second batch is received from the workflow application after the first batch.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a schematic drawing of a building equipped with an HVAC system, according to some embodiments.

FIG. 2 is a schematic drawing of a waterside system which can be used as part of the HVAC system of FIG. 1, according to some embodiments.

FIG. 3 is a block diagram of an airside system which can be used as part of the HVAC system of FIG. 1, according to some embodiments.

FIG. 4 is a block diagram of a BMS which can be used in the building of FIG. 1, according to some embodiments.

FIG. 5 is a block diagram of a connected workflow system that may be communicably coupled with the BMS of FIG. 4, according to some embodiments.

FIG. 6 is a flowchart of a connected workflow process, according to some embodiments.

FIG. 7 is a diagram of a workflow application interface, which may be populated with data from the cloud server of FIG. 6, according to some embodiments.

FIG. 8 is a diagram of a workflow dashboard interface, which may be populated with data from the cloud server of FIG. 6, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods for a connected workflow system are shown, according to various embodiments. The connected workflow system permits a user to execute testing of proper installation and commissioning of building devices and building equipment via a connection with a building controller or other devices.

Testing is conducted to confirm that building devices and equipment have been properly installed, configured, etc. at a building such that the building devices are in proper condition to efficiently heat, cool, ventilate, and/or otherwise affect one or more conditions of a building. Such testing can include collection of testing data including quantitative data, pass/fail results, free-text entries, notes or instructions for follow-up (e.g., punch list items to be corrected in equipment or device installation or configuration before testing will pass), among other possible information. A technical challenge exists in ensuring data integrity (e.g., reliability, accuracy, lack of errors, lack of contradictory information, etc.) in such information, especially for complex building systems, large construction sites, large buildings or campuses, etc.

For example, errors can occur when a user is inadvertently connected to a different device than expected or collecting data for a different floor, zone, section, etc. of a building than intended. Such data can be added over or in addition to correct data, thereby muddling together good, prior data (for which testing should not need to be re-performed) with erroneous information which can be hard to isolate and remove (e.g., as multiple users may be working and not have full visibility of errors created by others). Furthermore, traditional methods for tracking progress through such testing involve paper records which can be lost, become disorganized, be subject to user error in entering information, become out of date due if time is not taken to update said records, etc. As such, a technical challenge exists in the field of building systems (and particularly with respect to testing and validation of proper installation and configuration of building equipment) with respect to ensuring integrity of testing data.

The teachings herein relate to addressing such technical challenges through storing of, and allowing reversion to, multiple versions of testing data over time, including in an automated, digitally-driven manner. For example, a first batch of test data can be collected via a workflow application on a mobile device and upload to a cloud system that stores the first batch of test data as a first version. At a later time, a second batch of test data is collected via the workflow application and also upload to the cloud system. A second version is created at the cloud system in response to the second batch of test data, where the second version includes test data from both the first batch and the second batch. However, in some scenarios, a determination may be made (e.g., by a user or automatically) that an error exists in the second batch of test data (e.g., that the second batch of test data is associated with the wrong floor of a building, that the second batch of test data is associated with the wrong building controller, etc.) In such scenarios, the cloud system can revert from the second version to the first version, thus removing the errors associated with the second batch of the test data from the version maintained as the current, controlling version of test data. Data integrity, reliability, etc. is thereby achieved while eliminating a need to re-collected the first batch of test data or attempt to individually isolate and edit changes in the data on the cloud system associated with the second batch of test data. Technical improvements in building systems technology are thereby provided by the teachings herein.

To utilize the connected workflow system, a user may connect a mobile device to a network, BMS controller, or BMS and execute a test via a workflow application on a mobile device. The workflow application collects the test data from one or more building controllers and transmits the test data to a cloud server. The cloud server manages the test data. The cloud server organizes and stores the test data into versions for test data for the same building equipment or building controller. The cloud server permits a user to select a current version of the test data through a workflow application or a workflow dashboard. The workflow dashboard may executed by a user device.

In some instances, a first mobile device can transmit a first batch at a first time. A second mobile device can transmit a second batch a second time. The cloud server determines that the first batch and the second batch are associated with the same group of building equipment and sorts them as a first version and a second version of the test data. The second version of test data may include both the first and second batches. In other instances, a mobile device may update a version of the test data with a re-execution of the test. In other instances, a mobile device executes a first test and stores the first batch in a first local network and the mobile device executes a second test and stores the second batch in a second local network. The first batch and the second batch are transmitted to the cloud server.

### Building Management System and HVAC System

### HVAC System

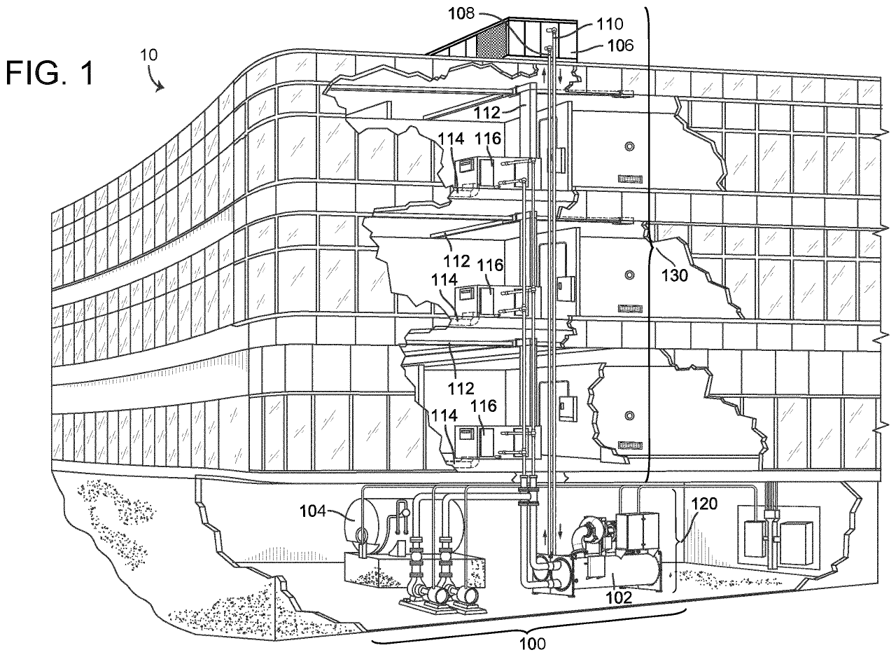

Referring now to FIG. 1, a perspective view of a building 10 is shown. Building 10 is served by a building management system (BMS). A BMS is, in general, a system of devices configured to control, monitor, and manage equipment in or around a building or building area. A BMS can include, for example, an HVAC system, a security system, a lighting system, a fire alerting system, any other system that is capable of managing building functions or devices, or any combination thereof.

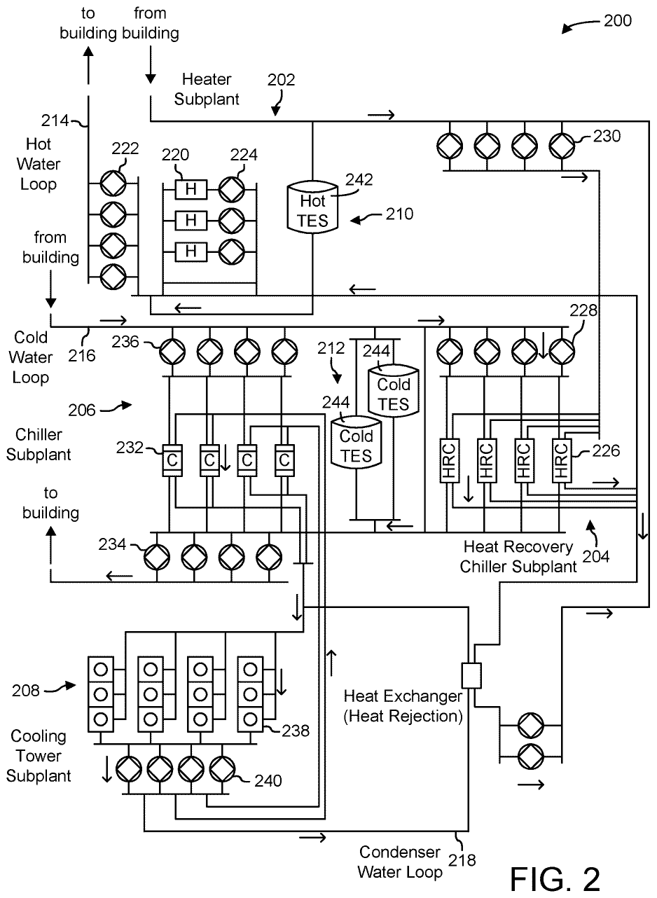

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. In some embodiments, waterside system 120 is replaced with a central energy plant such as central plant 200, described with reference to FIG. 2.

In some embodiments, building 10 acts as a building or campus (e.g., several buildings) capable of housing some or all components of HVAC system 100. While the systems and methods described herein are primarily focused on operations within a typical building (e.g., building 10), they can easily be applied to various other enclosures or spaces (e.g., cars, airplanes, recreational vehicles, etc.).

Still referring to FIG. 1, HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via air supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flowrate, temperature, or other attributes of the supply airflow through AHU 106 to achieve setpoint conditions for the building zone.

### Waterside System

Referring now to FIG. 2, a block diagram of a central plant 200 is shown, according to an exemplary embodiment. In brief overview, central plant 200 may include various types of equipment configured to serve the thermal energy loads of a building or campus (i.e., a system of buildings). For example, central plant 200 may include heaters, chillers, heat recovery chillers, cooling towers, or other types of equipment configured to serve the heating and/or cooling loads of a building or campus. Central plant 200 may consume resources from a utility (e.g., electricity, water, natural gas, etc.) to heat or cool a working fluid that is circulated to one or more buildings or stored for later use (e.g., in thermal energy storage tanks) to provide heating or cooling for the buildings. In various embodiments, central plant 200 may supplement or replace waterside system 120 in building 10 or may be implemented separate from building 10 (e.g., at an offsite location).

Central plant 200 is shown to include a plurality of subplants 202-212 including a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 and building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO₂, etc.) may be used in place of or in addition to water to serve the thermal energy loads. In other embodiments, subplants 202-212 may provide heating and/or cooling directly to the building or campus without requiring an intermediate heat transfer fluid. These and other variations to central plant 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flowrate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flowrate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flowrate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flowrate of the condenser water through individual cooling towers 238.

Hot TES subplant 210 is shown to include a hot TES tank 242 configured to store the hot water for later use. Hot TES subplant 210 may also include one or more pumps or valves configured to control the flowrate of the hot water into or out of hot TES tank 242. Cold TES subplant 212 is shown to include cold TES tanks 244 configured to store the cold water for later use. Cold TES subplant 212 may also include one or more pumps or valves configured to control the flowrate of the cold water into or out of cold TES tanks 244.

In some embodiments, one or more of the pumps in central plant 200 (e.g., pumps 222, 224, 228, 230, 234, 236, and/or 240) or pipelines in central plant 200 include an isolation valve associated therewith. Isolation valves may be integrated with the pumps or positioned upstream or downstream of the pumps to control the fluid flows in central plant 200. In various embodiments, central plant 200 may include more, fewer, or different types of devices and/or subplants based on the particular configuration of central plant 200 and the types of loads served by central plant 200.

### Airside System

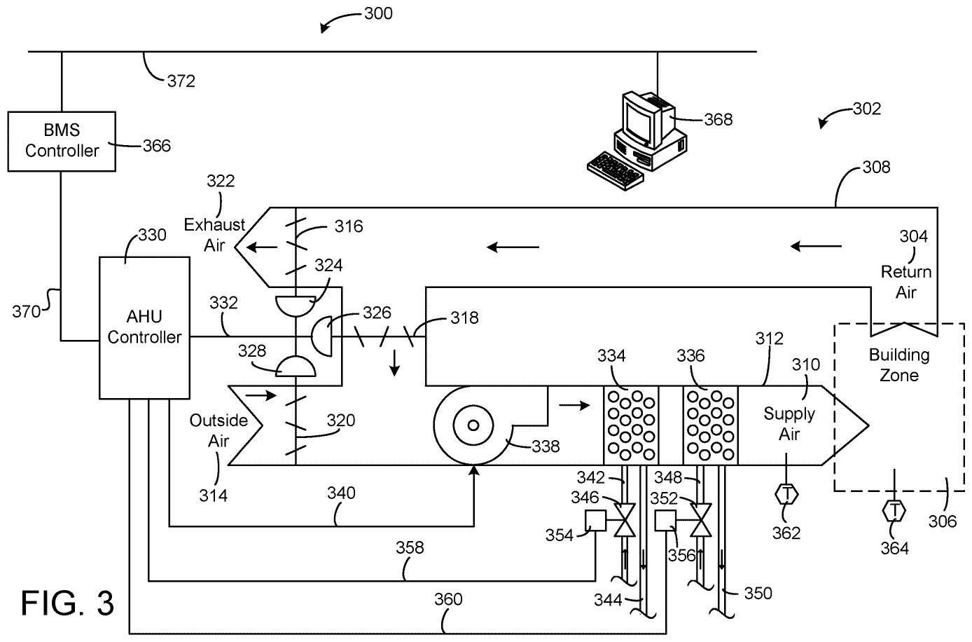

Referring now to FIG. 3, a block diagram of an airside system 300 is shown, according to an exemplary embodiment. In various embodiments, airside system 300 can supplement or replace airside system 130 in HVAC system 100, or can be implemented separate from HVAC system 100. When implemented in HVAC system 100, airside system 300 can include a subset of the HVAC devices in HVAC system 100 (e.g., AHU 106, VAV units 116, air supply ducts 112, air return ducts 114, fans, dampers, etc.) and can be located in or around building 10. Airside system 300 can operate to heat or cool an airflow provided to building 10 using a heated or chilled fluid provided by waterside system 120.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust air damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flowrate of supply air 310. In some embodiments, AHU controller 330 controls an amount of heating or cooling applied to supply air 310 by modulating a speed of fan 338.

Cooling coil 334 can receive a chilled fluid from waterside system 120 (e.g., from cold water loop 216) via piping 342 and can return the chilled fluid to waterside system 120 via piping 344. Valve 346 can be positioned along piping 342 or piping 344 to control a flowrate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 120 (e.g., from hot water loop 214) via piping 348 and can return the heated fluid to waterside system 120 via piping 350. Valve 352 can be positioned along piping 348 or piping 350 to control a flowrate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 120, HVAC system 100, and/or other controllable systems that serve building 10. BMS controller 366 can communicate with multiple downstream building systems or subsystems (e.g., HVAC system 100, a security system, a lighting system, waterside system 120, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362 and 364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

### Building Management System

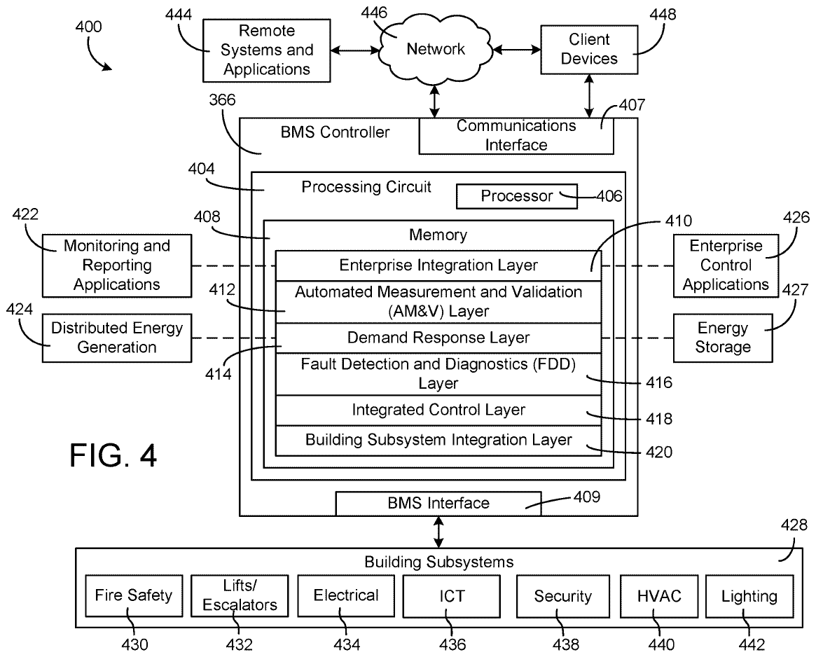

Referring now to FIG. 4, a block diagram of a building management system (BMS) 400 is shown, according to an exemplary embodiment. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, an HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 120 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIG. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices (e.g., card access, etc.) and servers, or other security-related devices.

Still referring to FIG. 4, BMS controller 366 is shown to include a communications interface 407 and a BMS interface 409. Communications interface 407 can facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Communications interface 407 can also facilitate communications between BMS controller 366 and client devices 448. BMS interface 409 can facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably coupled to BMS interface 409 and/or communications interface 407 such that processing circuit 404 and the various components thereof can send and receive data via interfaces 407, 409. Processor 406 can be implemented as a general purpose processor, an application-specific integrated circuit (ASIC), one or more field-programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present disclosure. Memory 408 can be or include volatile memory or non-volatile memory. Memory 408 can include database components, object code components, script components, or any other type of information structure for supporting the various activities and information structures described in the present disclosure. According to an exemplary embodiment, memory 408 is communicably coupled to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration layer 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 can also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at communications interface 407 and/or BMS interface 409.

Building subsystem integration layer 420 can be configured to manage communications between BMS controller 366 and building subsystems 428. For example, building subsystem integration layer 420 can receive sensor data and input signals from building subsystems 428 and provide output data and control signals to building subsystems 428. Building subsystem integration layer 420 can also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES tanks 242, cold TES 244vtank, etc.), or from other sources. Demand response layer 414 can receive inputs from other layers of BMS controller 366 (e.g., building subsystem integration layer 420, integrated control layer 418, etc.). The inputs received from other layers can include environmental or sensor inputs such as temperature, carbon di-oxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 can also include control logic configured to determine when to utilize stored energy. For example, demand response layer 414 can determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 414 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response layer 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 can compare a model-predicted output with an actual output from building subsystems 428 to determine an accuracy of the model.

Fault detection and diagnostics (FDD) layer 416 can be configured to provide ongoing fault detection for building subsystems 428, building subsystem devices (i.e., building equipment), and control algorithms used by demand response layer 414 and integrated control layer 418. FDD layer 416 can receive data inputs from integrated control layer 418, directly from one or more building subsystems or devices, or from another data source. FDD layer 416 can automatically diagnose and respond to detected faults. The responses to detected or diagnosed faults can include providing an alert message to a user, a maintenance scheduling system, or a control algorithm configured to attempt to repair the fault or to work around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) can shut down systems or direct control activities around faulty devices or systems to reduce energy waste, extend equipment life, or assure proper control response.

FDD layer 416 can be configured to store or access a variety of different system data stores (or data points for live data). FDD layer 416 can use some content of the data stores to identify faults at the equipment level (e.g., specific chiller, specific AHU, specific terminal unit, etc.) and other content to identify faults at component or subsystem levels. For example, building subsystems 428 can generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### BMS with a Connected Workflow

### Connected Workflow System

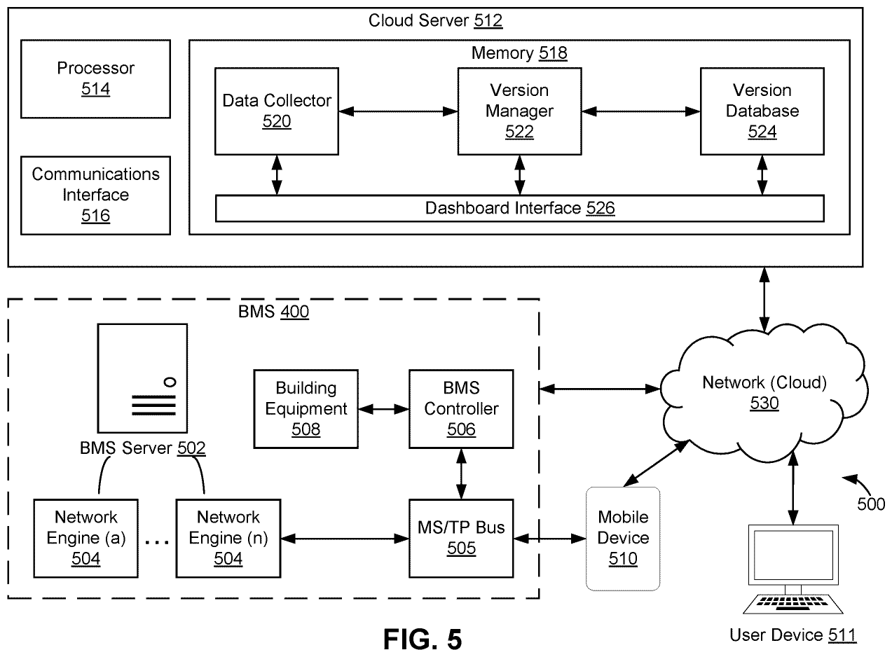

Referring now to FIG. 5, a block diagram of a connected workflow system 500 that may be communicably coupled with the BMS 400 of FIG. 4 is shown, according to some embodiments. The connected workflow system 500 is shown to include a BMS 400, a mobile device 510, a user device 511, a cloud server 512, and a network 530. In some embodiments, the connected workflow system 500 includes some or all of the BMS 400 within the building 10, as well as off-premises processing (e.g., cloud server 512) throughout which the various components communicate therewith over the network 530. In some embodiments, the connected workflow system 500 facilitates the transmission and storage of BMS data within building 10 (e.g., and other buildings, etc.) to an off-premises location, and provides means for processing the BMS data to determine updates (e.g., changes, differences, new equipment, new subsystems, etc.).

Referring still to FIG. 5, the BMS 400 is shown as including a BMS server 502, one or more network engines (e.g., network engine 504 (a)-(n)), a BMS controller 506, or building equipment 508. The BMS server 502 may be configured to store various components of the BMS 400 (e.g., monitoring and reporting application 422, enterprise control applications 426, remote systems and application 444, etc.). The BMS server 502 may be configured to store data or sequences for data processing or equipment control of other BMS components (e.g., network engine 504, BMS controller 506, building equipment 508, etc.). The BMS server 502 may be configured as data storage for the building 10. In some embodiments, the BMS server 502 may be communicatively coupled to the network engine 504. In some embodiments, the BMS 400 may include a series of BMS servers 502.

The network engine 504 shown to facilitate data transmission from and to the BMS server 502. The network engine 504 is shown to be communicatively coupled to a BMS controller 506 or building equipment 508. The network engine 504 may be configured to communicate with other devices (e.g., mobile device 510) or BMS components via a Master-Slave/Token Passing (MS/TP) Bus 505. The MS/TP bus 505 may be configured to facilitate data transmission via a BACnet MS/TP communication protocol. In some embodiments, the mobile device is configured with a Connected Workflow Wireless MS/TP Converter (CWCVT) to communicate with the MS/TP bus 505. The CWCVT is a converter that provides wireless connection between a device (e.g., mobile device 510, user device 511, etc.) and a BMS controller 506. The CWCVT may connect to the device by physical connection (e.g., plug-in, etc.) or a wireless connection (e.g., Bluetooth, etc.). In some embodiments, the mobile device 510 may be connected to the BMS 400 via an Internet Protocol (IP) network. In such embodiments, the MS/TP bus 505 may not be used. In such embodiments, the mobile device 510 may connect to the BMS 400 via an IP router. In some embodiments, the MS/TP bus 505 may be replaced with a communication bus configured to facilitate data transmission via a communication protocol.

The BMS controller 506 is configured to control or operate building equipment 508. The BMS controller 506 may be configured similarly to BMS controller 366 of FIG. 4. The building equipment 508 may include components of BMS systems (e.g., waterside system 120, airside system 130, central plant 200, building subsystems 428, etc.). In some embodiments, the BMS controller 506 may be configured to execute a test of building equipment 508. In such embodiments, the BMS controller 506 is configured to generate test data from a result of the test of the building equipment 508. The BMS controller 506 is shown to be configured to communicate with other devices or BMS components via a MS/TP bus 505.

Referring still to FIG. 5, the mobile device 510 may be a device (e.g., smartphone, tablet, workstation computer, etc.) configured to receive and display information (e.g., updates, notifications, messages, emails, etc.). In some embodiments, the mobile device 510 is configured to store and host an application. The application of the mobile device 510 may be configured to facilitate a user to interact with the information (e.g., via touch input, messaging, etc.). The application is shown to communicate with other device or systems (e.g., BMS 400, cloud server 512, etc.) via the network 530. In some embodiments, the mobile device 510 is configured communicate with the BMS 400 via a MS/TP protocol. In such embodiments, the mobile device 510 is configured to communicatively connect with the MS/TP bus 505. In some embodiments, the mobile device 510 is configured to transmit data to the cloud server 512.

Referring still to FIG. 5, the user device 511 may be a device (e.g., smartphone, tablet, workstation computer, etc.) configured to receive and display information (e.g., updates, notifications, messages, emails, etc.). In some embodiments, the user device 511 is configured to store and host an application. The application of the user device 511 may be configured to facilitate a user to interact with the information (e.g., via touch input, messaging, etc.). The application is shown to communicate with other device or systems (e.g., BMS 400, cloud server 512, etc.) via the network 530.

Referring still to FIG. 5, the cloud server 512 may be any processing device located off-premises (e.g., within the cloud, etc.). For example, cloud server 512 can be located in a data center in a different region (e.g., different state) than building 10. Cloud server 512 can be or include any number of processing devices that are configured to retrieve, store, process, and analyze BMS data from BMS 400 and/or other BMS systems from other buildings (e.g., a second building 10). In some embodiments, the cloud server 512 is implemented within a single computer (e.g., one server, one housing, etc.) of computing system. In other embodiments, the cloud server 512 may be distributed across multiple servers or computers (e.g., that can exist in distributed locations, that can exist in the same datacenter, etc.). The cloud server 512 is shown to include a processor 514, a communications interface 516, or a memory 518.

The processor 514 is communicably coupled to the communications interface 516 such that the processor 514 and the various components thereof can send and receive data via the communications interface 516. The processor 514 may be implemented as a general-purpose processor, an application-specific integrated circuit (ASIC), one or more field-programmable gate arrays (FPGAs), a group of processing components, or other suitable electronic processing components.

The communications interface 516 is configured to facilitate communications between the cloud server 512 and other devices and systems of the connected workflow system 500 (e.g., BMS 400, mobile device 510, user device 511, etc.) for allowing user control, monitoring, and adjustment to the cloud server 512.

The memory 518 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory 518 may include volatile memory or non-volatile memory. The memory 518 can include database components, object code components, script components, or any other type of information structure for supporting the various activities and information structures described in the present disclosure. According to an exemplary embodiment, the memory 518 may be communicably coupled to processor 604. The memory 518 may include computer code for executing (e.g., by the processor 514) one or more processes described herein. The memory 518 is shown to include a data collector 520, a version manager 522, a version database, or a dashboard interface 526.

The data collector 520 may be configured to receive the data from one or more of the servers, devices, and/or components (e.g., BMS server 502, network engine 504, (a)-(n), mobile device 510, user device 511, etc.). In some embodiments, the data collector 520 may be configured to receive data describing information about the BMS 400, the mobile device 510, the user device 511, or the network 530 (e.g., building equipment 508 type, BMS controller 506 name, test data of building equipment 508, network 530 name, mobile device 510 name, etc.). For example, the data collector 520 may receive data describing the name, last testing time, user notes, or test data about a chiller. In some embodiments, the cloud server 512 may be configured to organize or arrange the received data. The cloud server 512 may be configured to sort the received data in the version database 524 based on user-defined categories (e.g., equipment name, equipment type, associated network or server, etc.).

The version manager 522 may be configured to receive data and perform processing to generate data describing additional information about the received data (e.g., number of data points, number of data points, time data was received, etc.). For example, the version manager 522 is configured to receive test data of building equipment 508 in the airside system 300 and determine the number of building equipment 508 based on the amount of received test data. The version manager 522 may be configured to generate data based on the data stored in the version database 524. For example, the version manager 522 may generate data to indicate that the received data is a duplicate or different from the stored data (e.g., a version number, test data status, etc.). The version manager 522 may be configured to generate data based on a user interacting with the cloud server 512. For example, the version manager 522 may generate a data to indicate that a set of data is preferred by a user.

The version database 524 is configured to store data received by the data collector 520 or generated by the version manager 522. The version database 524 may be configured to store data from the BMS 400, mobile device 510, user device 511 or other devices or systems from the connected workflow system 500 or building 10 (e.g., test data from building equipment 508, data from BMS controller 506). The version database 524 may be configured to store data in predefined categories such as project name, server name, network name, network status, controller name, equipment name, equipment status, equipment notes, test date, last modified date, user names, etc. In some embodiments, the version database 524 is configured to store a series of test data for the building equipment 508. In such embodiments, the series of data may be organized into “versions” or multiple batches of data. For example, the test data for an HVAC system may include a first batch of data, labeled as “version 1”, and a second batch of data, labeled as “version 2.” In such example, the version 1 data describes test data for 50% of HVAC system equipment and the version 2 data describes test data for 70% of HVAC system equipment.

The dashboard interface 526 is configured to host and generate an interface for display the data in the memory 518. The dashboard interface 526 is configured to facilitate a user interacting with the cloud server 512 (e.g., a graphical button, a free-text box, etc.). The dashboard interface 526 may be configured to permit a user to execute processes of the cloud server 512. For example, the dashboard interface 526 can generate a graphical button to permit a user to command the version manager 522 to indicate a preferred version of the test data. The dashboard interface 526 may be configured as a server-hosted website. The dashboard interface 526 is shown to be accessed or executed by a mobile device 510 or a user device 511.

Network 530 is shown to communicatively couple to the devices and systems of the connected workflow system 500. In some embodiments, the network 530 is at least one of and/or a combination of a Wi-Fi network, a wired Ethernet network, a ZigBee network, a Bluetooth network, and/or any other wireless network. The network 530 may be a local area network or a wide area network (e.g., the Internet, a building WAN, etc.) and may use a variety of communications protocols (e.g., BACnet, BACnet/IP, BACnet/Ethernet, LON, etc.). The network 530 may include routers, modems, servers, cell towers, satellites, and/or network switches. The network 530 may include a series of wired and wireless networks (e.g., a first network, a second network, etc.). In some embodiments, the network 530 may include a first network to connect devices and systems located in the building 10 and a second network to connect the first network to the cloud server 512. In some embodiments, the network 530 may include a first network and a second network to connect devices and systems located in the building 10.

### Connected Workflow Process

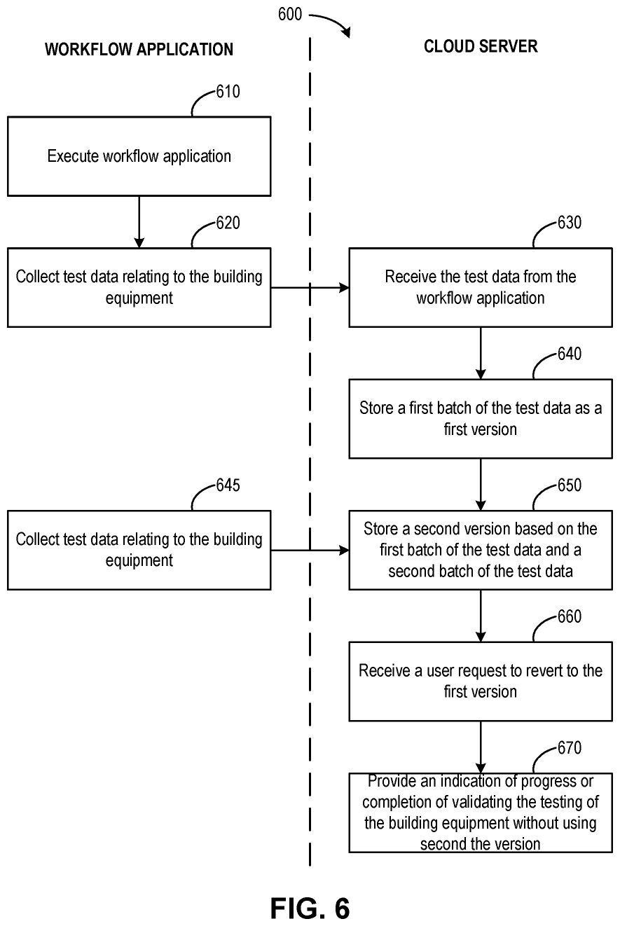

Referring now to FIG. 6, a flowchart of a connected workflow process 600 is shown, according to some embodiments. Process 600 may be performed by any of the processing components described herein. Process 600 may be performed by multiple devices and systems in the connected workflow system 500.

Step 610 includes executing a workflow application. Step 610 may include executing the workflow application by a mobile device 510. Step 610 may include connecting the workflow application to a network 530 that is coupled to a BMS 400. Step 610 may include the workflow application displaying building equipment 508. Step 610 may include displaying building equipment 508 coupled to a series of networks 530. For example, a first series of building equipment 508 is coupled to a first network and second series of building equipment 508 is coupled to a second network. Step 610 may include displaying the building equipment 508 in groups based on relationships with other devices and system in the connect workflow system 500. For example, a first series of building equipment 508 may be associated with a first BMS controller 506 and a second series of building equipment 508 may be associated with a second BMS controller 506. In such example, the first series of building equipment 508 and the second series of building equipment 508 may further be associated with a first network or a first server. Step 610 may include displaying the building equipment 508 in user-defined groups (e.g., “projects”, etc.). Step 610 may include displaying an indication of the progression, status, or completion of the testing of building equipment 508. Step 610 may include displaying user interface features to facilitate a user to interact with other components of the connected workflow system 500 (e.g., graphical buttons that execute a testing of the building equipment 508, a reverting of testing data of building equipment 508, etc.). In some embodiments, the workflow application may be executed by a series of mobile devices 510 at different timepoints.

Step 620 includes collecting test data relating to the building equipment 508. Step 620 may include commanding, via interacting with the workflow application, a BMS controller 506 to execute a test of the building equipment 508. Step 620 may include selecting a building equipment or a series of building equipment based on groupings (e.g., by a shared BMS controller 506, a shared network 530, a shared BMS server 502, user-defined “projects”, etc.). For example, a user may select to test HVAC equipment associated with a first BMS controller 506. Step 620 may include the BMS controller 506 operating the building equipment 508 in a test sequence or procedure and generating test data based on a results of the test of the building equipment 508. Step 620 may include transmitting the test data from a building controller, one or more sensors in the building, or other building device to the workflow application. In some embodiments, collecting test data may include collecting test data at different timepoints. In some embodiments, collecting test data may include collecting test data from the same building equipment 508 or BMS controller 506 at different timepoints.

In some embodiments, Step 620 may include determining a time to transmit the test data to the cloud server 512. In some embodiments, step 630 includes transmitting the test data in response to a user interacting with the workflow application (e.g., pressing a “send data” button, etc.). In other embodiments, step 620 includes transmitting the test data in response to a condition of the workflow application (e.g., closing the workflow application, disconnecting the workflow application from the network 530, etc.). Step 620 may include storing the test data in a BMS server 502 and transmitting the test data to the cloud server 512 from the BMS server 502. Step 620 may include organizing or sorting the test data based on the characteristics of the test data (e.g., based on time of test, building equipment 508 tested, BMS controller 506, etc.). In some embodiments, the test data may be stored in a series of BMS servers 502.

Step 630 includes receiving the test data from the workflow application (e.g., from the mobile device 510). Step 630 may include receiving the test data by a cloud server 512.

Step 640 includes storing a first batch of the test data as a first version. Step 640 may include storing the first version by the cloud server 512. Step 640 may include identifying the building equipment 508 or BMS controller 506 that is associated with the first batch based on the received test data. Step 640 may include parsing a version database 524 and determining that the version database 524 does not include a previous version associated with the identified building equipment 508 or BMS controller 506, and saving the first batch as all data for the first version in response to such a determination. If a previous version exists, the first batch of test data can be added to the previous version and saved in step 640. Step 640 may include storing the first batch in the version database 524.

Step 645 includes collecting additional test data relating to the building equipment 508, in particular a second batch of test data. Step 645 may include similar methods as Steps 610 and 620.

Step 650 includes storing a second version based on the first batch of the test data and the second batch of the test data from step 645. At step 645, the second batch of test data is combined with the first version stored in step 640 (and which includes the first batch of test data) and stored as a second version. The second version thus differs from the first version in that it also includes the second batch of test data which had not yet been collected or provided to the cloud server 512 when the first version was created. Step 650 is performed while retaining (without deleting) the first version. Step 650 can include setting the second version as a current version of the testing and validation status for a building system, for example for use in providing information on completion of testing and validation to a user (e.g., via user device 511) and/or guiding and implementing execution of remaining tests to be completed via the workflow application on the mobile device 510.

Step 660 includes receiving a user request to revert from the second version to the first version. Step 660 may include receiving the user request by the cloud server 512. Step 660 may include generating and transmitting the user request from a workflow application or a workflow dashboard. Step 660 may include executing the workflow application or a workflow dashboard by a mobile device 510 or a user device 511. Step 660 may include determining that the second version includes test data that is not preferred by a user (e.g., test data that is associated with the wrong device or equipment; test data that is inaccurate due to sensor error, user error, or other issue; etc.). For example, the second version might include test data for building equipment 508 that was a user had associated with a first device or unit of the building equipment 508 via the workflow application but which actually corresponded to a second device or unit of the building equipment 508, such that the second batch of test data (and thus the second version) includes erroneous test data and completion status information. In some embodiments, reverting to the first version can include generating a third version of the test data by copying or reorganizing the first version into a third version (e.g., creating a version of the test data without re-execution of the test of the building equipment 508 to generate the first batch.), for example such that process 600 includes maintaining a full history of versions including separate entries for when a version is initially created and in response to a request to revert to a previous version.

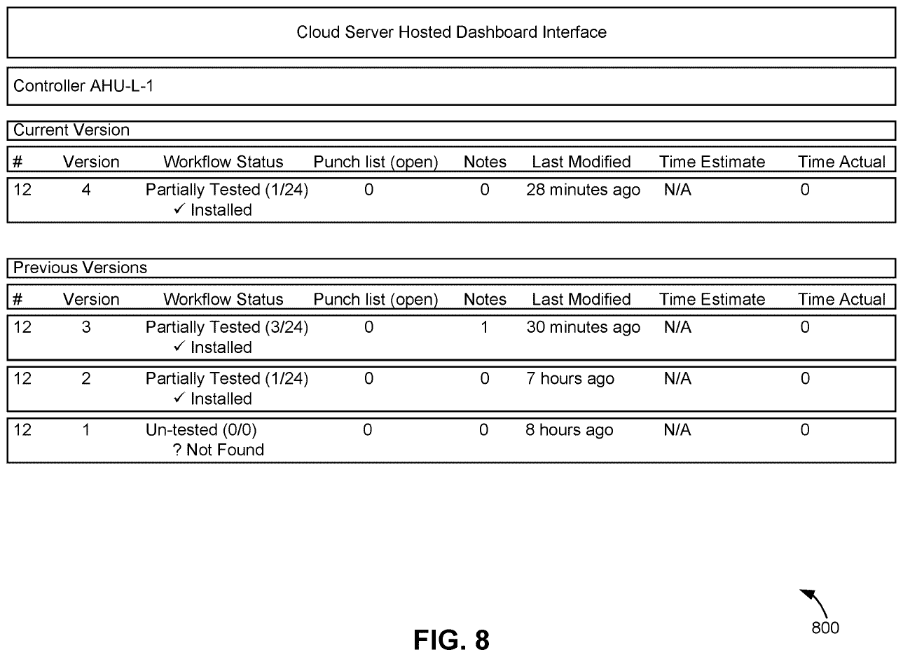

Step 670 includes providing an indication of progress or completion of validating the testing of the building equipment based on the first version and without using the second version in response to reverting to the first version in step 660. Step 670 may include displaying a graphical user interface of the indication in a workflow application or a workflow dashboard. For example, a dashboard or report (e.g., as in FIG. 8) showing test status and other information can be updated from showing information corresponding to the second version to show information corresponding to the first version. Step 670 may include instructing the workflow application to cause a re-execution of the test of the building equipment 508 in response to the user request to revert to the first version (e.g., re-executing of the test of the building equipment 508 to generate a third batch to replace the second version or to supplement the first version).

By storing versions of test data and enabling reversion to prior versions, process 600 ensures data integrity (e.g., accuracy, consistency, reliability, etc.) in the context of commissioning, testing, and validation of building equipment being installed at a building. Process 600 thereby addresses technical challenges associated with confirming that building equipment has been properly installed and configured, particularly in large, complex buildings, building systems, construction sites, etc. where such testing reports and records have previously been stored in paper files (which were prone to be lost, left out of date, including human errors, etc.). Additionally, process 600 can be executed in a manner that allows multiple users, mobiles devices 510, or user devices 511 to access, view, and add to or otherwise modify the test data at various times and locations, enable coordination while mitigating the risk that an action of one user will create data errors which cannot be easily isolated and removed by another user (or otherwise at a later point in time). Technical advantages in data integrity and reliability for testing of building equipment are thereby provided by process 600.

In some embodiments, the process 600 includes connecting the user device 510 to a BMS 400 by a MS/TP bus 505 configured to facilitate a transmission of the test data from the BMS controller to the first mobile device. In such embodiment, the user device 510 communicates to other components of the BMS 400, via a MS/TP protocol, in the network 530 or building 10 associated to the MS/TP bus 505. For example, a building 10 can include a first series of building equipment 508 associated with a first MS/TP bus 505 and a second series of building equipment 508 associated with a second MS/TP bus 505. In such example, Steps 610-620 includes connecting the mobile device 510 to the first MS/TP bus 505 and displaying the first series of building equipment 508 without showing the second series of building equipment 508.

In some embodiments, the process 600 includes transmitting the test data of building equipment 508 from different sources at different times. For example, Step 620 includes collecting a first batch of test data of the building equipment 508 from a first mobile device 510 at a first time. Step 645 includes collecting a second batch of test data of the building equipment from a second mobile device 510 at a second time. In such example, Step 650 includes associating the first batch and the second batch to a BMS controller 506 or building equipment 508 and storing the second batch as a second version (e.g., ‘BMS controller Version 1’, ‘BMS controller Version 2’, etc.). In another example, Step 620 includes storing and transmitting the first batch of the test data from a first BMS server 502 and storing and transmitting the second batch of the test data from a second BMS server 502.

### Connected Workflow Interfaces

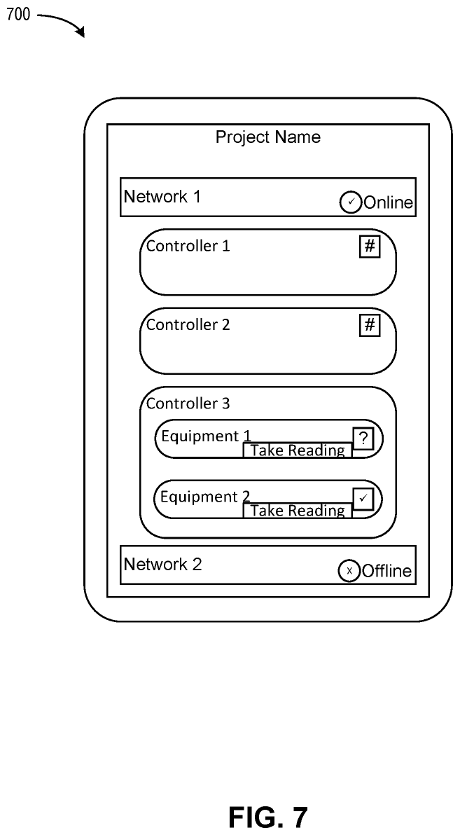

Referring now to FIG. 7, diagram of a workflow application interface 700, which may be populated with data from the cloud server 512 of FIG. 6, is shown, according to some embodiments. The workflow application is configured to generate and display a graphical interface for a user. In some embodiments, some or all of the icons shown within diagram may be interacted with by a user (e.g., via a click, touch, etc.). For example, a user can select a “network” to view the BMS controller 506 or building equipment 508 associated with a network 530 or BMS server 502 (e.g., coupled to a local network, located in the local building 10, coupled to a local BMS server 502, etc.). The workflow application interface 700 may be configured to be executed by a mobile device 510 or a user device 511. The workflow application interface 700 may be configured to facilitate the functions of the connected workflow system 500 or the Process 600.

The diagram of the workflow application interface 700 includes data describing groups or a series of networks 530 (“Network 1” and “Network 2”), a series of building controllers 506 (“Controller 1,” “Controller 2,” and “Controller 3”) associated with “Network 1”, and a series of building equipment 508 (“Equipment 1” and “Equipment 2”) associated with “Controller 3.” The diagram of the workflow application interface 700 includes a data describing a user-defined group (“Project Name”) that associates the networks 530 (“Network 1” and “Network 2”), the building controllers 506 (“Controller 1,” “Controller 2,” and “Controller 3”), and the building equipment 508 (“Equipment 1” and “Equipment 2”).

The displays of the networks 530 may include data describing a status of the networks 530 (“Online” and “Offline”). The displays of the building controllers 506 may include data describing the number of building equipment 508 associated with the respective building controller 506 (denoted as “#”). The displays of the building equipment 508 may include data describing the progression or completion of testing of the respective building equipment 508 (denoted as “?” and “✓”).

The diagram of the workflow application interface 700 includes graphical interface displays to facilitate interacting with the BMS 400 or the cloud server 512. For example, the building equipment 508 (“Equipment 1” and “Equipment 2”) includes a button (“Take Reading”) to execute the workflow application causing collection of the test data of the respective building equipment 508 (e.g., Steps 620 of Process 600). In some embodiments, the workflow application interface 700 includes graphical interface displays to execute commands to modify or control the test data. For example, a graphical interface display may be generated to allow a user to command a batch of test data to be transmitted to the cloud server 512 (e.g., Steps 610 and 645 of Process 600).

Referring now to FIG. 8, diagram of a workflow dashboard interface 800, which may be populated with data from the cloud server 512 of FIG. 6, is shown, according to some embodiments. The workflow dashboard is configured to generate and display a graphical interface for a user. In some embodiments, some or all of the icons shown within diagram may be interacted with by a user (e.g., via a click, touch, etc.). For example, a user can select a BMS controller 506 (“Controller AHU-L-1”) to view the test data associated with the BMS controller 506 or building equipment 508 associated with the BMS controller 506 (e.g., coupled to the BMS controller 506, operated by the BMS controller 506, etc.). The workflow dashboard interface 800 may be configured to be executed by a mobile device 510 or a user device 511. The workflow dashboard interface 800 may be configured as the dashboard interface 526. The workflow dashboard interface 800 may be configured to facilitate the functions of the connected workflow system 500 or the Process 600.

The diagram of the workflow dashboard interface 800 includes data describing groups or a series of test data. The workflow dashboard interface 800 may include data describing a version history of the test data (“Current Version” and “Previous Versions”). The workflow dashboard interface 800 may include data describing characteristics of the test data (number of building equipment 508, denoted as “#”; “Version”; “Workflow Status”; “Punch List”; “Notes”; “Last Modified”; “Time Estimate”; and “Time Actual”).

The displays of test data may include data describing the version of the test data (“1-4”). The displays of the test data may include data describing a workflow status (“Partially Tested (1/24), ✓ Installed” and “Un-Tested (0/0), ? Not Found”). The displays of the test data may include data describing a Punch List (“0”). The displays of the test data may include data describing notes (“0” and “1”). The displays of the test data may include data describing last modified times of the test data (e.g., “28 minutes ago,” “30 minutes ago,” etc.). The displays of the test data may include data describing a time estimate of the testing (“N/A”). The displays of the test data may include data describing an actual time of the testing (“0”). The displays may interacted with by a user (e.g., via touch, via click, etc.) to generate another graphical interface to display information about the respective display (e.g., clicking “Partially Tested (1/24)” may generate a display with the test data).

The diagram of the workflow dashboard interface 800 includes graphical interface displays to facilitate interacting with the BMS 400 or the cloud server 512. For example, the displays of a test data version may permit a user to select a preferred or “Current Version” of the test data. The workflow dashboard interface 800 may include a button, input field, option, etc. to permit a user to send a request to revert to a previous version (e.g., Step 660 of Process 600). In response to such a request, the information displayed in workflow dashboard interface 800 is updated to reflect the selected, previous version of the test data. For example, the number of tests completed will be updated, as will punch list and notes information, or any other data that may be stored in a version in various embodiments. The workflow dashboard interface 800 thus enables a user to view a current version and revert to, and then view, a different version of the relevant data, thereby ensuring data integrity via access to prior versions if an error or issue is determined with respect to the current version of data displayed on the workflow dashboard interface 800.

### Configuration of Exemplary Embodiments

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent, or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application-specific integrated circuit (ASIC), a field-programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media (e.g., non-transitory computer readable media (CRM), etc.) for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of various systems (e.g., system 100, central plant 200, etc.) and methods as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A system for validating testing of building equipment, the system comprising:
a first mobile device configured to execute a workflow application causing a first collection of test data relating to the building equipment;
a computing system configured to:
receive the test data from the workflow application;
store a first batch of the test data as a first version;
store a second version based on the first batch of the test data and a second batch of the test data, the second batch received from the workflow application after the first batch; and
provide an indication of progress or completion of validating the testing of the building equipment without using the second version in response to a user request to revert to the first version.

2. The system of claim 1, wherein:
the second batch includes a result of a test of the building equipment, and
the computing system is configured to instruct the workflow application to cause a re-execution of the test of the building equipment in response to the user request to revert to the first version.

3. The system of claim 1, wherein the computing system is configured to provide a graphical user interface comprising the indication.

4. The system of claim 1, further comprising a second mobile device configured to execute the workflow application causing a second collection of the test data relating to the building equipment.

5. The system of claim 1, further comprising a building management system (BMS) controller configured to:
execute a test of the building equipment in response to the executing of the workflow application, and
generate the test data from a result of the test of the building equipment.

6. The system of claim 1, further comprising:
a BMS controller configured to generate the test data from a result of the test of the building equipment; and
a communication bus configured to facilitate a transmission of the test data from the BMS controller to the first mobile device via a communication protocol.

7. The system of claim 1, further comprising a user device configured to execute a workflow dashboard causing generation of the user request to revert to the first version.

8. The system of claim 1, wherein:
the first mobile device is further configured to transmit the first batch of the test data to the computing system; and
the system further comprises a second mobile device configured to transmit the second batch of the test data to the computing system.

9. One or more non-transitory computer readable media storing program instructions related to validating testing of building equipment, wherein, when executed by one or more processors, the program instructions causes the one or more processors to perform operations comprising:
receiving test data from a workflow application;
storing a first batch of the test data as a first version;
storing a second version based on the first batch of the test data and a second batch of the test data, the second batch received from the workflow application after the first batch; and
providing an indication of progress or completion of validating the testing of the building equipment without using the second version in response to a user request to revert to the first version.

10. The media of claim 9, wherein the operations further comprise instructing the workflow application to cause a re-execution of the test of the building equipment in response to the user request to revert to the first version.

11. The media of claim 9, wherein the operations further comprise providing a graphical user interface comprising the indication.

12. The media of claim 9, wherein the test data comprises quantitative data and free-text notes.

13. The media of claim 9, wherein the operations further comprises causing, based on the indication, a building management system controller to execute a test of the building equipment.

14. The media of claim 9, wherein providing the indication of progress or completion validating the testing of the building equipment comprises causing the workflow application to re-execute a test for which test data was included in the second batch.

15. The media of claim 9, wherein the operations comprise generating a workflow dashboard configured to receive the user request to revert to the first version and to present the indication.

16. The media of claim 9, wherein the operations comprise:
receiving the first batch of the test data from a first mobile device; and
receiving the second batch of the test data from a second mobile device.

17. A method to validate testing of building equipment, the method comprising:
receiving test data from a workflow application executed to cause collection of the test data relating to building equipment;
storing, by a cloud server, a first batch of the test data as a first version;
storing, by a cloud server, a second version based on the first batch of the test data and a second batch of the test data, the second batch received from the workflow application after the first batch; and
providing an indication of progress or completion of validating a testing of the building equipment without using the second version in response to a user request to revert to the first version.

18. The method of claim 17, wherein the providing the indication of progress or completion of validating the testing of the building equipment comprises instructing the workflow application to cause a re-execution of the test of the building equipment in response to the user request to revert to the first version.

19. The method of claim 17, wherein the receiving the test data from the workflow application comprises:
collecting the first batch of the test data from a BMS controller;
collecting the second batch of the test data from the BMS controller; and
associating the first batch of the test data and the second batch of the test data to the BMS controller.

20. The method of claim 17, wherein the receiving the test data from the workflow application comprises:
receiving the first batch of the test data from a first mobile device;
receiving the second batch of the test data from a second mobile device; and
associating the first batch of the test data and the second batch of the test data to a BMS controller.
